(19) United States
(12) Patent Application Publication
(10) Pub. No.: US 2024/0001229 A1
(43) Pub. Date: Jan. 4, 2024

(54) VIBRATION DEVICE AND LOCAL VIBRATION ADJUSTMENT METHOD THEREFOR, AND ELECTRONIC EQUIPMENT

(71) Applicant: Shanghai awinic Technology Co., Ltd., Shanghai (CN)

(72) Inventor: Peiliang YU, Shanghai (CN)

(73) Assignee: Shanghai awinic Technology Co., Ltd., Shanghai, 20 (CN)

(21) Appl. No.: 18/251,909

(22) PCT Filed: Nov. 5, 2021
(86) PCT No.: PCT/CN2021/128919

§ 371 Date: May 5, 2023

(30) Foreign Application Priority Data
Nov. 5, 2020 (CN) 202011221072.0

(51) Int. Cl. A63F 13/285; G06F 3/01; B06B 1/02

(52) U.S. Cl. CPC A63F 13/285; G06F 3/016; B06B 1/0253; B06B 2201/30

(57) ABSTRACT

A vibration apparatus and a local vibration adjustment method therefor, and an electronic device are provided. The vibration apparatus includes: two or more excitation modules, a vibration sensing module and a processing module. The vibration sensing module may obtain a vibration sensing signal in a non-target vibration region while target haptic sensation is generated in a target vibration region. The processing module drives, based on the vibration sensing signal, an excitation module in the non-target vibration region to generate corresponding damping vibration to counteract the non-target vibration, thereby weakening the vibration in the non-target vibration region.

This application claims priority to Chinese Patent Application No. 202011221072.0, titled “VIBRATION DEVICE AND LOCAL VIBRATION ADJUSTMENT METHOD THEREFOR, AND ELECTRONIC EQUIPMENT”, filed on Nov. 5, 2020 with the China National Intellectual Property Administration, which is incorporated herein by reference in its entirety.

### FIELD

The present disclosure relates to the technical field of electronic devices, and in particular to a vibration apparatus and a local vibration adjustment method therefor, and an electronic device.

### BACKGROUND

In an electronic device such as a portable information terminal and a game console, a vibration apparatus is often arranged to perform call notification vibration, touch vibration, haptic feedback in the game consoles, and the like, so that the user in using the electronic device can better interact with the electronic device.

In order to improve the user's body feeling, it is required to realize ideal local vibration in electronic devices such as game phones and game handles. In general, motors are arranged in an electronic device to realize vibration, and the motors in vibrating may drive the whole electronic device to vibrate due to the transmission of vibration. Even if different motors are arranged in different parts of the electronic device to perform vibration control, it is still difficult to realize the ideal local vibration.

How to reduce a non-target vibration to improve the local vibration effect is a problem to be urgently solved at present.

### SUMMARY

In view of this, a vibration apparatus and a local vibration adjustment method therefor, and an electronic device are provided according to the present disclosure to solve the problem that how to improve the local vibration effect.

A vibration apparatus is provided according to the present disclosure. The vibration apparatus includes: two or more excitation modules, a vibration sensing module and a processing module. The two or more excitation modules correspond to two or more vibration regions. Each of the excitation modules corresponds to one of the vibration regions, each of the excitation modules is configured to apply vibration to a vibration region corresponding to the excitation module. The two or more vibration regions include at least one target vibration region and at least one non-target vibration region. The vibration sensing module is arranged in the non-target vibration region, and is configured to obtain a vibration sensing signal of the non-target vibration region. The processing module is connected to the excitation modules and the vibration sensing module, and is configured to transmit a vibration control signal based on a requirement of target haptic sensation. The processing module is further configured to transmit a first vibration control signal to the excitation module corresponding to the target vibration region to generate the target haptic sensation in the target vibration region; and based on the vibration sensing signal obtained by the vibration sensing module arranged in the non-target vibration region, transmit a second vibration control signal to the excitation module corresponding to the non-target vibration region to apply damping vibration to the non-target vibration region, where the damping vibration has a phase opposite to a phase of a current vibration in the non-target vibration region.

In an embodiment, each of the excitation modules includes an exciter and a driver. The exciter is arranged in a vibration region corresponding to the excitation module. The driver of the excitation module corresponding to the target vibration region is configured to receive the first vibration control signal and drive, based on the first vibration control signal, and the exciter of the excitation module corresponding to the target vibration region to generate target vibration having a frequency and an intensity corresponding to the first vibration control signal. The driver of the excitation module corresponding to the non-target vibration region is configured to receive the second vibration control signal and drive, based on the second vibration control signal, the exciter of the excitation module corresponding to the non-target vibration region to generate the damping vibration having a frequency and an intensity corresponding to the second vibration control signal.

In an embodiment, a vibration sensing module is arranged in each of the at least one non-target vibration region.

In an embodiment, a vibration sensing module is arranged in each of the vibration regions.

In an embodiment, the vibration sensing module includes at least one vibration sensor. The vibration sensor includes at least one of an acceleration sensor, a speed sensor, and an eddy current sensor.

In an embodiment, each of the at least one vibration sensor is arranged on an extension line along a vibration direction of an excitation module in a vibration region.

In an embodiment, the exciter in the non-target vibration region has two or more vibration directions.

In an embodiment, the vibration sensing module includes multiple scalar vibration sensors. The scalar vibration sensors are configured to obtain vibration sensing signals in different directions.

In an embodiment, the vibration sensing module includes a vector vibration sensor.

In an embodiment, the processing module includes a calculation unit and a control unit. The calculation unit is configured to convert the obtained vibration sensing signal to a characteristic value of non-target vibration in the non-target vibration region. The control unit is configured to generate the second vibration control signal based on the characteristic value of the non-target vibration received from the calculation unit.

A local vibration adjustment method is further provided according to the present disclosure. The method includes: applying vibration to a target vibration region to generate target vibration in the target vibration region; obtaining, during the vibration of the target vibration region, a characteristic value of non-target vibration in a non-target vibration region; and applying, based on the characteristic value of the non-target vibration in the non-target vibration region, damping vibration having a phase opposite to a phase of the non-target vibration to the non-target vibration region.

In an embodiment, the characteristic value of the non-target vibration includes a phase, an amplitude, a direction, and a frequency.

In an embodiment, the feature value of the non-target vibration includes at least a characteristic value of a vibration component of the non-target vibration in one direction, and a direction of the damping vibration is the same as a direction of at least one vibration component of the non-target vibration.

An electronic device is further provided according to the present disclosure. The electronic device includes the vibration apparatus described above. The excitation modules in the vibration apparatus correspond to vibration regions of the electronic device.

In an embodiment, the electronic device further includes an apparatus. The apparatus is configured to generate a requirement of target haptic sensation based on a trigger event.

The vibration-reduction apparatus according to the present disclosure includes a vibration sensing module. The vibration sensing module may obtain a vibration sensing signal in a non-target vibration region while target haptic sensation is generated in a target vibration region. The processing module drives, based on the vibration sensing signal, an excitation module in the non-target vibration region to generate a corresponding damping vibration to counteract the non-target vibration, thereby weakening/suppressing the vibration in the non-target vibration region. With the vibration sensing module directly detecting the vibration of the non-target vibration region, the actual vibration of the non-target vibration region can be accurately reflected by the vibration sensing signal, and damping vibration is applied to the non-target vibration region, efficiently reducing vibration without being affected by external environment.

### BRIEF DESCRIPTION OF THE DRAWINGS

In order to more clearly illustrate the technical solutions in the embodiments of the present disclosure, the accompanying drawings used in the description of the embodiments are briefly described hereinafter. It is apparent that the following accompanying drawings only illustrate some of the embodiments of the present disclosure, and other accompanying drawings can be obtained by those skilled in the art based on the accompanying drawings without creative efforts.

FIG. 1 is a schematic structural diagram of a vibration apparatus according to an embodiment of the present disclosure;

FIG. 2 is a schematic diagram of vibration waveforms in performing vibration reduction control according to an embodiment of the present disclosure;

FIG. 3 is a schematic structural diagram of a vibration apparatus according to another embodiment of the present disclosure;

FIG. 4 is a schematic structural diagram of a vibration apparatus according to another embodiment of the present disclosure;

FIG. 5 is a schematic structural diagram of a vibration apparatus according to another embodiment of the present disclosure;

FIG. 6 is a flowchart of a local vibration adjustment method according to an embodiment of the present disclosure; and

FIG. 7 is a schematic diagram showing a structure of an electronic device and a damping effect according to an embodiment of the present disclosure.

### DETAILED DESCRIPTION OF THE EMBODIMENTS

As described in the background technology, due to the transmission of vibration in electronic device, follow-up vibration is often generated in regions other than the target vibration region, affecting the effect of local vibration.

It is found that since the transmission of vibration is affected by various conditions such as the structure of the device and the ambient temperature, it is difficult to accurately reduce the vibration in the non-target vibration region based on the calculation of vibration transmission.

Therefore, a closed-loop control solution is provided according to the present disclosure to reduce the impact of the external environment and improve the accuracy and the application range of local vibration reduction control.

The technical solutions in the embodiments of the present disclosure are clearly and completely described below in conjunction with the accompanying drawings. Apparently, the described embodiments are only some of the embodiments of the present disclosure, rather than all of the embodiments. Based on the embodiments in the present disclosure, all other embodiments obtained by those skilled in the art without creative efforts fall within the scope of protection of the present disclosure. If there is no conflict, the following embodiments and the technical features in the embodiments may be combined with each other.

The vibration apparatus according to the present disclosure includes: two or more excitation modules, a vibration sensing module and a processing module. The two or more excitation modules correspond to two or more vibration regions. Each of the excitation modules corresponds to one of the vibration regions. Each of the excitation modules applies vibration to a vibration region corresponding to the excitation module. The two or more vibration regions include at least one target vibration region and at least one non-target vibration region. The vibration sensing module is configured to obtain a vibration sensing signal in a non-target vibration region. The processing module is connected to the excitation modules in the vibration regions and the vibration sensing module. The processing module is configured to transmit a first vibration control signal to an excitation module in the target vibration region based on a requirement of target haptic sensation to generate target haptic sensation in the target vibration region; and transmit a second vibration control signal to an excitation module in the non-target vibration region based on the vibration sensing signal detected by the vibration sensing module in the non-target vibration region. Thus, the excitation module in the non-target vibration region generates a vibration having a phase opposite to a characteristic value of a current vibration.

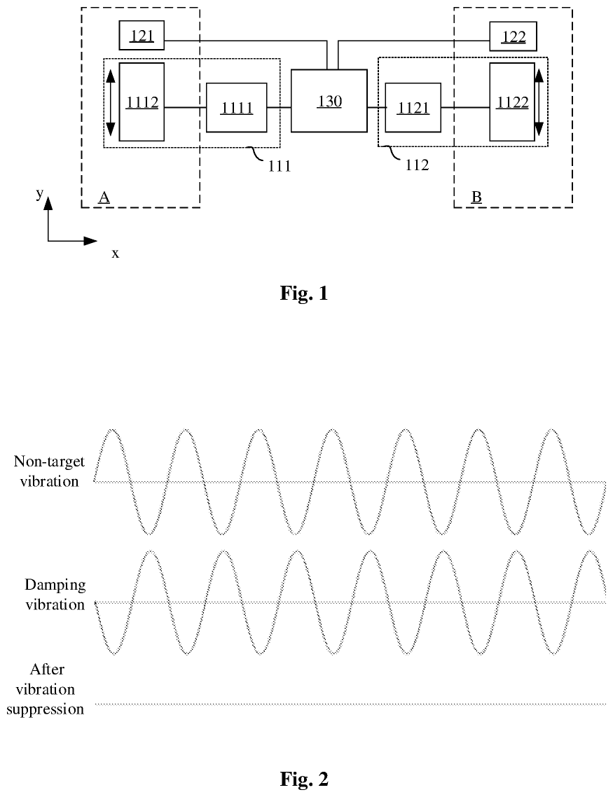

Reference is made to FIG. 1, which is a schematic structural diagram of a vibration apparatus according to an embodiment of the present disclosure.

In the embodiment, the vibration apparatus includes two excitation modules: a first excitation module 111 and a second excitation module 112. The first excitation module 111 corresponds to a vibration region A. The first excitation module 111 vibrates to generate vibration in the vibration region A. The second excitation module 112 corresponds to a vibration region B. The second excitation module 112 vibrates to generate vibration in the vibration region B.

The first excitation module 111 includes a first driver 1111 and a first exciter 1112, and the second excitation module 112 includes a second driver 1121 and a second exciter 1122.

The first exciter 1112 and the second exciter 1122 may be various types of vibration motors, including one or more of a voice coil motor, a linear motor, a rotor motor, and the like. A single exciter may include one or more vibration motors to generate vibration in a single direction or vibration in multiple directions. The first exciter 1112 is arranged in the vibration region A, and the second exciter 1122 is arranged in the vibration region B.

The first driver 1111 is configured to receive a vibration control signal, and transmit a drive signal to the first exciter 1112 based on the received vibration control signal to drive the first exciter 1112 to vibrate, converting electrical energy to mechanical energy. In a case that the vibration region A is a target vibration region, the vibration control signal received by the first driver 1111 is a first vibration control signal for generating target vibration. In a case that the vibration region A is a non-target vibration region, the vibration control signal received by the first driver 1111 is a second vibration control signal for generating damping vibration.

The second driver 1121 is configured to receive a vibration control signal, and transmit a drive signal to the second exciter 1122 based on the received vibration control signal to drive the second exciter 1122 to vibrate, converting electrical energy to mechanical energy. In a case that the vibration region B is a target vibration region, the vibration control signal received by the second driver 1121 is a second vibration control signal for generating damping vibration. In a case that the vibration region B is a non-target vibration region, the vibration control signal received by the second driver 1112 is a first vibration control signal for generating target vibration.

The drive signal may be a voltage signal or a current signal. An amplitude, a deviation and a phase of vibration of an exciter are controlled based on a strength, a frequency and a phase of the drive signal. Depending on the type of vibration motor, the first driver 1111 and the second driver 1121 may be a direct current drive circuit, an alternate current drive circuit, or the like. Those skilled in the art may select an appropriate exciter and a corresponding driver according to the actual requirements, which is not limited in the present disclosure. In the embodiment shown in FIG. 1, the first driver 1111 and the second driver 1121 are arranged outside the vibration region A and the vibration region B. In other embodiments, the first driver 1111 and the second driver 1121 may be respectively arranged in the vibration region A and the vibration region B. Those skilled in the art may reasonably arrange the first driver 1111 and the second driver 1121 according to the device layout in the electronic device.

One of the vibration region A and the vibration region B is a target vibration region, and the other one of the vibration region A and the vibration region B is a non-target vibration region. The vibration region A and vibration region B are usually predetermined regions in the electronic device. In some embodiments, it is required to generate target vibration only in one predetermine region of the electronic device. For example, the vibration region A is configured as a target vibration region and the vibration region B is configured as a non-target vibration region, then it is required to perform vibration reduction control in the non-target vibration region B to avoid vibration in the vibration region B caused by vibration in the vibration region A. In other embodiments, both the vibration region A and the vibration region B may be configured as target vibration regions. For example, in a case of electronic devices such as game consoles, two regions in which holding positions of both hands are located are vibration regions, and it is required to perform target vibration alternately in the two regions. In this case, the target vibration region and the non-target vibration region are not constantly configured, and it is required to configure the target vibration region and the non-target vibration region according to a requirement of a target haptic sensation. In a case of multiple vibration regions, a vibration region in which it is required to generate vibration is configured as a target vibration region, and a region in which it is unnecessary to generate vibration is configured as a non-target vibration region.

In some embodiments, both the vibration region A and the vibration region B may be the target vibration region. The vibration region A and the vibration region B may be two handheld regions of the electronic device. According to the user's left and right hand operation habits, a handheld region corresponding to a master hand may be configured as a target vibration region. During the operation of the electronic device, the target vibration region may be changed in real time based on content of a response event. For example, in running a game, the vibration region A and the vibration region B may alternately configured as the target vibration region according to the change of the content scene of the game, providing the user with a good immersive experience.

The vibration apparatus further includes a first vibration sensing module 121 and a second vibration sensing module 122. The first vibration sensing module 121 is arranged in the vibration region A and the second vibration sensing module 122 is arranged in the vibration region B. In a case that the vibration region A is a target vibration region and the vibration region B is a non-target vibration region, a vibration sensing signal of the vibration region B is obtained by using the second vibration sensing module 122. In a case that the vibration region A is a non-target vibration region and the vibration region B is a target vibration region, a vibration sensing signal of the vibration region A is obtained by using the first vibration sensing module 121. In other embodiments, in a case that the target vibration region and the non-target vibration region are constantly configured, a vibration sensing module may be arranged only in the non-target vibration region to obtain the vibration sensing signal in the non-target vibration region. In a case that the target vibration region and the non-target vibration region are configured flexibly, a vibration sensing module may be arranged in each of the vibration regions.

Each of the first vibration sensing module 121 and the second vibration sensing module 122 includes at least one vibration sensor. The vibration sensor includes at least one of an acceleration sensor, a speed sensor, and an eddy current sensor. The vibration sensor may detect a characteristic value of vibration. The characteristic value includes one or more of a vibration phase, a vibration direction, a vibration intensity, a vibration frequency, and the like. The vibration sensor may be a scalar vibration sensor or a vector vibration sensor. The scalar vibration sensor may obtain a characteristic value of vibration. The vector vibration sensor may obtain a characteristic value of vibration, and may obtain a vibration direction corresponding to the characteristic value of the vibration.

In an embodiment, both the first exciter 1112 and the second exciter 1122 may only vibrate in a single direction along a y-axis direction. The first vibration sensing module 121 and the second vibration sensing module 122 are scalar vibration sensors. In order to accurately obtain characteristic values of vibration at the positions of the first exciter 1112 and the second exciter 1122, the first vibration sensing module 121 is arranged on an extension line along a vibration direction of the excitation module in the vibration region A, and the second vibration sensing module 122 is arranged on an extension line along a vibration direction of the excitation module in the vibration region B. Specifically, the first vibration sensing module 121 is arranged near an end of the first exciter 1112 along the y-axis direction, and is arranged on the same line along the y-axis direction with the first exciter 1112. The second vibration sensing module 122 is arranged near an end of the second exciter 1122 along the y-axis direction, and is arranged on the same line along the y-axis direction with the second exciter 1122. That the first vibration sensing module 121 is arranged on the same line along the y-axis direction with the first exciter 1112 indicates that centers of the first vibration sensing module 121 and the first exciter 1112 are almost located on the same line, and that the second vibration sensing module 122 is arranged on the same line along the y-axis direction with the second exciter 1122 indicates that centers of the second vibration sensing module 122 and the second exciter 1122 are almost located on the same line.

The processing module 130 is connected to the first excitation module 111 and the second excitation module 112, and is configured to transmit a vibration control signal to the first excitation module 111 to control the first excitation module 111 to apply vibration to the vibration region A and transmit a vibration control signal to the second excitation module 112 to control the second excitation module 112 to apply vibration to the vibration region B. The processing module 130 is further connected to the vibration sensing module, and is configured to receive, from the vibration sensing module, a vibration detection signal of the non-target vibration region in which the vibration sensing module is arranged and transmit a vibration control signal for reducing vibration to an excitation module in the non-target vibration region to drive the excitation module in the non-target vibration region to perform damping vibration.

Illustration is provided by taking the vibration region A as a target vibration region and the vibration region B as a non-target vibration region as an example.

The processing module 130 is configured to transmit a first vibration control signal to the first excitation module 111 based on a requirement of target haptic sensation to generate the target haptic sensation in the vibration region A. Specifically, a first driver 1111 in the first excitation module 111 receives the first vibration control signal, generates a corresponding drive signal, and transmits the drive signal to the first exciter 1112 in the vibration region A. Then, the first exciter 1112 generates vibration having a particular characteristic value, such that the vibration generated in the vibration region A meets the target haptic sensation requirement.

The processing module 130 is further configured to receive a vibration sensing signal of the vibration region B obtained by the second vibration sensing module 122, and transmit a second vibration control signal to the second excitation module 112 based on the vibration sensing signal to suppress/damp the vibration in the vibration region B. Specifically, a second driver 1121 in the second excitation module 112 receives the second vibration control signal, generates a corresponding drive signal, and transmits the drive signal to the second exciter 1122 in the vibration region B. Then, the second exciter 1122 generates damping vibration to counteract the non-target vibration in the vibration region B caused by the vibration in the vibration region A, weakening/suppressing the vibration in the vibration region B.

In some embodiments, the processing module 130 includes a calculation unit and a control unit. The calculation unit is configured to convert the received vibration sensing signal from the non-target sensing region to a characteristic value of non-target vibration in the non-target vibration region. The control unit is configured to generate the second vibration control signal based on the characteristic value of the non-target vibration received from the calculation unit.

Due to the limitation of physical positions of the second vibration sensing module 122 and the second exciter 1122 and the attenuation effect of the vibration with distance, there is a deviation between the characteristic value of the vibration corresponding to the vibration sensing signal detected by the second vibration sensing module 122 and the characteristic value of the vibration at the actual position of the second exciter 1122. The damping vibration having a phase opposite to the phase of the current vibration generated only based on the vibration sensing signal cannot accurately counteract the vibration at the second exciter 1122. In some embodiments, the characteristic value of the vibration corresponding to the vibration sensing signal obtained by the second vibration sensing module 122 may be calibrated in advance with the actual characteristic value of the vibration at the position of the second exciter 1122 to obtain a corresponding relationship between the vibration sensing signal and the actual characteristic value of the vibration at the position of the second exciter 1122. Then, based on the corresponding relationship, an accurate second vibration control signal is obtained, thereby performing accurate vibration reduction control for the vibration region B.

In an embodiment, a vibration reduction/suppression target may be set according to requirements. For example, the vibration in the vibration region B may be counteracted by using the second exciter 1122, so that there is almost no vibration in the vibration region B. Alternatively, the vibration in the vibration region B may be reduced according to the requirements.

Reference is made to FIG. 2, which is a schematic diagram of vibration waveforms in performing vibration reduction control on the vibration region B according to an embodiment of the present disclosure.

In conjunction with FIG. 1, a non-target vibration is generated in the vibration region B during the vibration of the vibration region A. Damping vibration having a phase opposite to the phase of the non-target vibration, a same frequency as the non-target vibration, a same amplitude as the non-target vibration, and a direction opposite to the direction of the non-target vibration is applied by using the second exciter 1122 in the vibration region B to counteract the non-target vibration, so that there is no vibration in the vibration region B after performing vibration reduction control.

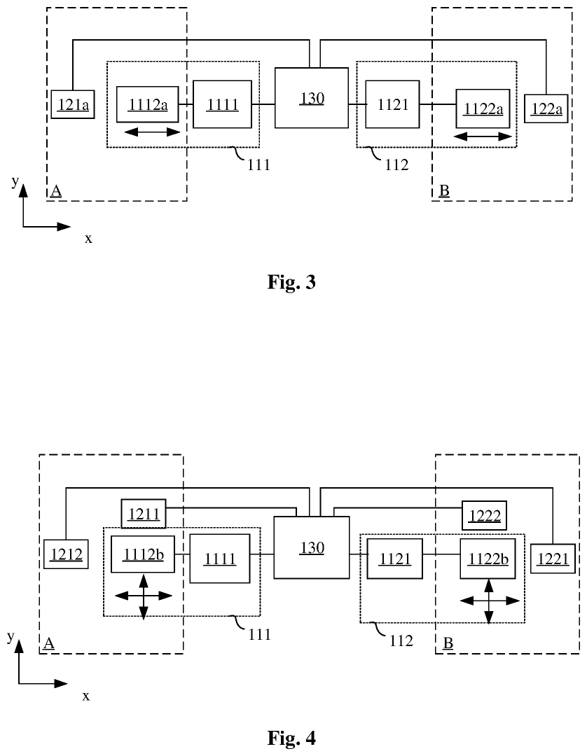

Reference is made to FIG. 3, which is a schematic structural diagram of a vibration apparatus according to another embodiment of the present disclosure.

In the embodiment, the difference from the embodiment shown in FIG. 1 is that a first exciter 1112a in the vibration region A and a second exciter 1122a in the vibration region B vibrate along the X axis direction. A first vibration sensing module 121a is arranged at an end of a first exciter 1112a along the x-axis direction, and is arranged along the x-axis direction with the first exciter 1112a. A second vibration sensing module 122a is arranged at an end of a second exciter 2122a along the x-axis direction, and is distributed along the x-axis direction with the second exciter 1122a. Then, characteristic values of vibration of the first exciter 1112a and the second exciter 1122a along the x-axis direction can be accurately obtained.

Reference is made to FIG. 4, which is a schematic structural diagram of a vibration apparatus according to another embodiment of the present disclosure.

In the embodiment, a first exciter 1112b and a second exciter 1122b may vibrate along the X-axis direction and the Y-axis direction.

Specifically, the first exciter 1112b and the second exciter 1122b may include a single multi-directional vibration motor, may include multiple unidirectional vibration motors having different vibration directions or may include both a multi-directional vibration motor and a unidirectional vibration motor to perform vibration in the X-axis direction and the Y-axis direction. The first driver 1111 may drive the first exciter 1112b to vibrate in one or two directions at the same time.

Correspondingly, the second vibration sensing module includes two vibration sensors, including a vibration sensor 1221 and a vibration sensor 1222. The vibration sensor 1221 and the vibration sensor 1222 are respectively arranged on extension lines of the second exciter 1122 along the x-axis direction and the y-axis direction, and are arranged to be close to the second exciter 1122. The vibration sensor 1221 is configured to detect vibration in the vibration region B along the x-axis direction, and the vibration sensor 1222 is configured to detect vibration in the vibration region B along the y-axis direction. Thus, when vibration along the x-axis direction and/or along the y-axis direction is generated in the vibration region A, a characteristic value of non-target vibration along the x-axis direction and/or along the y-axis direction in the vibration region B may be detected, and then damping vibration in the direction is applied.

Correspondingly, the first vibration sensing module includes two vibration sensors, including a vibration sensor 1211 and a vibration sensor 1212. The vibration sensor 1211 and the vibration sensor 1212 are respectively arranged on extension lines of the first exciter 1112 along the x-axis direction and the y-axis direction, and are arranged to be close to the first exciter 1112. In a case that the vibration region B is configured as the target vibration region, characteristic values of non-target vibration in the vibration region A along the x-axis direction and the y-axis direction are detected. In some embodiments, a single vector sensor may be only arranged in the non-target vibration region to detect a vibration amount and a vibration direction.

In other embodiments, the excitation module may generate vibration in a z-axis direction, that is, the excitation module may provide vibration in a direction perpendicular to an x-y plane. Then, the vibration sensor is arranged to be close to the exciter of the vibration module to accurately obtain the characteristic value of vibration of the exciter.

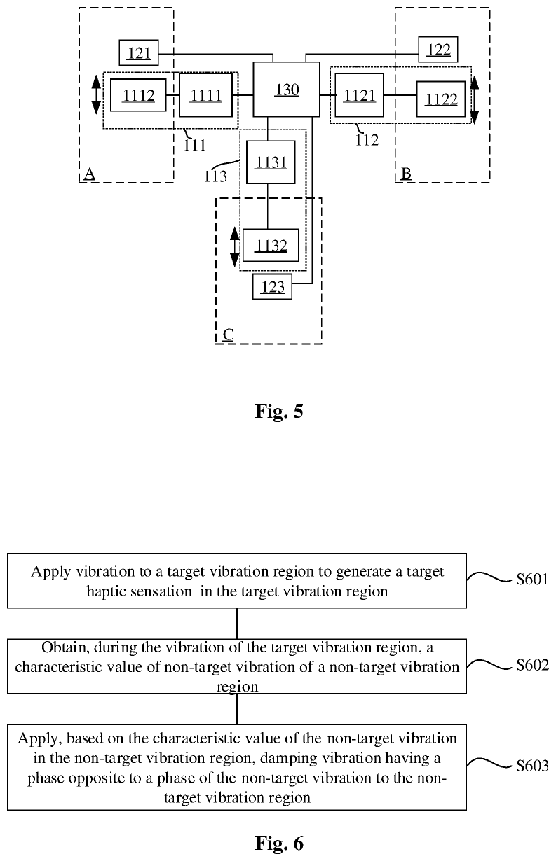

Reference is made to FIG. 5, which is a schematic structural diagram of a vibration apparatus according to another embodiment of the present disclosure.

In the embodiment, the vibration apparatus is applicable to three vibration regions: a vibration region A, a vibration region B and a vibration region C.

The vibration region A corresponds to a first excitation module 111, the vibration region B corresponds to a second excitation module 112, and the vibration region C corresponds to a third excitation module 113. The first excitation module 111 includes a first driver 1111 and a first exciter 1112, the second excitation module 112 includes a second driver 1121 and a second exciter 1122, and the third excitation module 113 includes a third driver 1131 and a third exciter 1132.

The vibration apparatus further includes vibration sensing modules 121, 122 and 123. The vibration sensing modules 121, 122 and 123 are respectively arranged in the vibration region A, the vibration region B and the vibration region C to detect vibration in the vibration regions and feedback vibration detection signals to the processor 130.

In an embodiment, both the vibration region A and the vibration region B are configured as target vibration regions and the vibration region C is configured as a non-target vibration region. Non-target vibration is generated in the vibration region C due to the transmission of target vibration generated in the vibration region A and the vibration region B, and the direction of the non-target vibration in the vibration region C is determined by the direction of the vibration in the vibration region A and the direction of the vibration in the vibration region B.

In another embodiment, both the vibration region A and the vibration region B are configured as non-target vibration regions, and the vibration region C is configured as a target vibration region. When target vibration is generated in the vibration region C, non-target vibration is generated in the vibration region A and the vibration region B due to the transmission of vibration. The non-target vibration in the vibration region A is related to a relative position and a distance between the vibration region A and the vibration region C, and the non-target vibration in the vibration region B is related to a relative position and a distance between the vibration region B and the vibration region C. Damping vibration may be applied to the vibration region A by using the first exciter 1112 to counteract the non-target vibration in the vibration region A, and damping vibration may be applied to the vibration region B by using the second exciter 1122 to counteract the non-target vibration in the vibration region B.

In other embodiments, the number of the target vibration region and the number of the non-target vibration region are not limited, and may be appropriately configured according to actual requirements.

In some embodiments, in a case that the target vibration region is configured constantly, an excitation module for reducing vibration may be arranged in the non-target vibration region. The vibration direction of the exciter in the excitation module is the same as the vibration direction of the exciter in the target vibration region. The vibration sensor may be appropriately arranged in the vibration sensing module based on the vibration direction to improve the effect of vibration reduction.

In other embodiments, in a case that multiple vibration regions may be configured as the target vibration regions, the vibration directions of the excitation modules corresponding to the multiple vibration regions configured according to target vibration requirements of the different vibration regions, and may be a same direction or different directions. In this case, in applying damping vibration to the non-target vibration region, if the direction of the target vibration is not consistent with the direction of the damping vibration, the vibration in the non-target vibration region may not be completely eliminated. In some embodiments, a target excitation module and a damping vibration excitation module may be arranged in each of the vibration regions. The target excitation module is configured to provide target vibration, and the damping vibration excitation module is configured to provide damping vibration. The damping vibration excitation module may have multiple vibration directions to meet damping vibration requirements of the target vibration region in different vibration directions.

The vibration apparatus includes a vibration sensing module. The vibration sensing module may obtain a vibration sensing signal in a non-target vibration region while target vibration is generated in a target vibration region. The processing module drives, based on the vibration sensing signal, an excitation module in the non-target vibration region to generate corresponding damping vibration to counteract the non-target vibration, thereby weakening the vibration in the non-target vibration region. With the vibration sensing module directly detecting the vibration of the non-target vibration region, the actual vibration of the non-target vibration region can be accurately reflected by the vibration sensing signal, and damping vibration is applied to the non-target vibration region, efficiently reducing vibration without being affected by external environment.

A local vibration adjustment method is further provided according to an embodiment of the present disclosure.

Reference is made to FIG. 6, which is a schematic diagram of a local vibration adjustment method according to an embodiment of the present disclosure.

The local vibration adjustment method includes the following steps S601 to S603.

In step S601, vibration is applied to a target vibration region to generate target target haptic sensation in the target vibration region.

Vibration in one or more directions may be applied to the target vibration region by using various types of vibration motors, such as one or more of a voice coil motor, a linear motor, and a rotor motors. According to a target vibration requirement, a corresponding drive signal is provided to the vibration motor to drive the vibration motor to vibrate, converting electrical energy to mechanical energy. The amplitude, deviation and phase of vibration of the motor are controlled based on the intensity, frequency, and phase of the target vibration, generating target haptic sensation in the target vibration region.

In step S602, a characteristic value of non-target vibration in a non-target vibration region is obtained during the vibration of the target vibration region.

During the vibration of the target vibration region, the vibration may be transmitted to other non-target vibration regions, resulting in unnecessary vibration and affecting the user's experience. The vibration in the non-target vibration regions may be detected by using a vibration sensor. The vibration sensor includes at least one of an acceleration sensor, a speed sensor and an eddy current sensor, and the vibration sensor may detect a characteristic value of the vibration. The characteristic value includes at least a phase, a direction, an intensity and a frequency of vibration. The vibration sensor may be a scalar vibration sensor or a vector vibration sensor. The scalar vibration sensor may obtain a characteristic value of vibration. The vector vibration sensor may obtain a characteristic value of vibration, and may obtain a vibration direction corresponding to the characteristic value of the vibration.

In step S603, based on the characteristic value of the non-target vibration in the non-target vibration region, damping vibration having a phase opposite to a phase of the non-target vibration is applied to the non-target vibration region.

Based on the characteristic value of the non-target vibration, damping vibration is applied to the non-target vibration region. The damping vibration has a phase opposite to the phase of the non-target vibration, so that the vibration caused by the non-target vibration may be reduced/suppressed.

In an embodiment, damping vibration having an amplitude and a frequency same as the amplitude and frequency of the non-target vibration and having a direction opposite to the direction of the non-target vibration is performed to counteract the non-target vibration, so that there is almost no vibration in the non-target vibration region. In some embodiments, parameters of the damping vibration may be adjusted according to requirements to reduce the non-target vibration to a certain extent.

In some embodiments, the non-target vibration includes vibration components in multiple directions. In the step S602, a characteristic value of a vibration component of the non-target vibration in at least one direction may be obtained. In step 603, damping vibration is applied in the direction of the vibration component. The direction of the damping vibration is at least the same as the direction of a vibration component of the non-target vibration. The non-target vibration in one or more directions may be reduced based on the cost and the device space.

An electronic device is further provided according to an embodiment of the present disclosure. The electronic device includes the vibration apparatus described in the above embodiments. The excitation modules in the vibration apparatus correspond to vibration regions of the electronic device to provide vibration for the vibration regions.

The electronic device further includes an apparatus for responding to a trigger event and generating a corresponding requirement of the target haptic sensation, such as a CPU (central processing unit), MCU (microprocessor), and a single chip computer. The apparatus is configured to respond to a trigger event and transmit a corresponding target vibration control signal to the processing module 130 (referring to FIG. 1). The processing module 130 is configured to determine, based on the requirement of the target haptic sensation, at least one of vibration regions as a target vibration region, and transmit a first vibration control signal to an excitation module corresponding to the target vibration region, thereby generating target vibration in the target vibration region. In addition, the vibration apparatus reduces vibration in other non-target vibration regions.

The trigger event may be various reminders, such as an incoming call reminder and a message notification, generated during the operation of the electronic device. In response to the trigger event, it is required to generate target haptic sensation in a target region. The trigger event may be a content event in running software of the electronic device. For example, the content event may be a shooting operation in running a shooting game or a specific content displayed in playing a video. Target vibration matching the content event is generated to improve the interactive experience between the user and the content. By performing vibration reduction control, interference of the non-target vibration in the non-vibration region may be avoided, thereby further improving the user's experience.

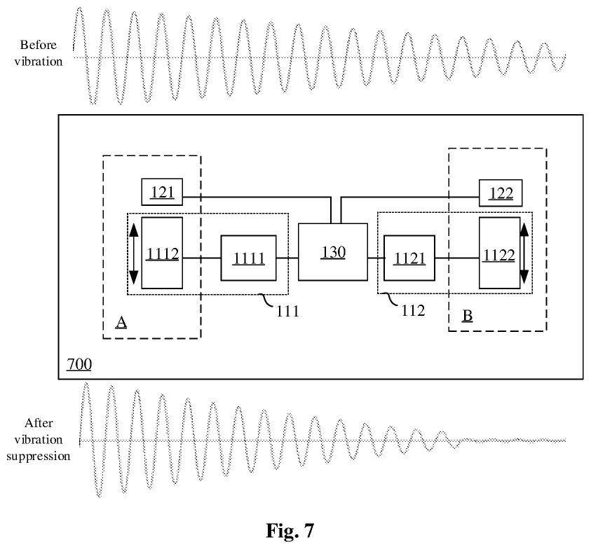

Reference is made to FIG. 7, which is a schematic diagram showing a structure of an electronic device and a damping effect according to an embodiment of the present disclosure.

In the embodiment, the device 700 includes the vibration apparatus as shown in FIG. 1, and the vibration apparatus is applied to a vibration region A and a vibration region B. The device 700 may be a mobile phone, and the vibration region A and the vibration region B are handheld positions at both ends of the mobile phone in a horizontal screen state. Though the vibration region A and the vibration region B, vibration experience may be provided to the user's hands when the user plays a video game or is in other situations using the mobile phone in the horizontal screen state.

In a case that it is only required to configure the vibration region A as a target vibration region based on the content played on the screen, if no vibration reduction control is performed, the target vibration in the vibration region A may be transmitted to the vibration region B, and then the user may feel vibration through both hands, reducing the user's experience of the target vibration from the vibration region A and deviating the interaction between the user and the content played on the screen due to the non-target vibration in the vibration region B.

In an embodiment of the present disclosure, damping vibration may be applied to the vibration region B by using the exciter 1122 in the target vibration region B, so that there is almost no vibration in the vibration region B after applying damping vibration to the vibration region B, thereby enhancing the user's sense of vibration in the vibration region A and reducing the interference of the non-target vibration in the vibration region B.

According to the above description of the disclosed embodiments, those skilled in the art can implement or practice the present disclosure. Many modifications to these embodiments are apparent for those skilled in the art. The general principles defined herein may be applied to other embodiments without departing from the spirit or scope of the present disclosure. Therefore, the present disclosure should not be limited to the embodiments disclosed herein, but has the widest scope in accordance to the principle and the novel features disclosed herein.

1. A vibration apparatus, comprising:
two or more excitation modules corresponding to two or more vibration regions, wherein each of the excitation modules corresponds to one of the vibration regions, each of the excitation modules is configured to apply vibration to a vibration region corresponding to the excitation module, and the two or more vibration regions comprise at least one target vibration region and at least one non-target vibration region;
a vibration sensing module, arranged in the non-target vibration region and configured to obtain a vibration sensing signal of the non-target vibration region; and
a processing module, connected to the excitation modules and the vibration sensing module, and configured to transmit a vibration control signal based on a requirement of target haptic sensation by:
transmitting a first vibration control signal to the excitation module corresponding to the target vibration region to generate the target haptic sensation in the target vibration region; and
based on the vibration sensing signal obtained by the vibration sensing module in the non-target vibration region, transmitting a second vibration control signal to the excitation module corresponding to the non-target vibration region to apply damping vibration to the non-target vibration region, wherein the damping vibration has a phase opposite to a phase of a current vibration in the non-target vibration region.

2. The vibration apparatus according to claim 1, wherein
each of the excitation modules comprises an exciter and a driver, and the exciter is arranged in the vibration region corresponding to the excitation module;
the driver of the excitation module corresponding to the target vibration region is configured to receive the first vibration control signal and drive, based on the first vibration control signal, the exciter of the excitation module corresponding to the target vibration region to generate target vibration having a frequency and an intensity corresponding to the first vibration control signal; and
the driver of the excitation module corresponding to the non-target vibration region is configured to receive the second vibration control signal and drive, based on the second vibration control signal, the exciter of the excitation module corresponding to the non-target vibration region to generate the damping vibration having a frequency and an intensity corresponding to the second vibration control signal.

3. The vibration apparatus according to claim 1, wherein a vibration sensing module is arranged in each of the at least one non-target vibration region.

4. The vibration apparatus according to claim 1, wherein a vibration sensing module is arranged in each of the vibration regions.

5. The vibration apparatus according to claim 1, wherein the vibration sensing module comprises at least one vibration sensor, and the vibration sensor comprises at least one of an acceleration sensor, a speed sensor and an eddy current sensor.

6. The vibration apparatus according to claim 5, wherein each of the at least one vibration sensor is arranged on an extension line along a vibration direction of an excitation module in a vibration region.

7. The vibration apparatus according to claim 2, wherein the exciter in the non-target vibration region has two or more vibration directions.

8. The vibration apparatus according to claim 1, wherein the vibration sensing module comprises a plurality of scalar vibration sensors, and the scalar vibration sensors are configured to obtain vibration sensing signals in different directions.

9. The vibration apparatus according to claim 1, wherein the vibration sensing module comprises a vector vibration sensor.

10. The vibration apparatus according to claim 1, wherein the processing module comprises a calculation unit and a control unit, the calculation unit is configured to convert the obtained vibration sensing signal to a characteristic value of non-target vibration in the non-target vibration region, and the control unit is configured to generate the second vibration control signal based on the characteristic value of the non-target vibration received from the calculation unit.

11. A local vibration adjustment method, comprising:
applying vibration to a target vibration region to generate target haptic sensation in the target vibration region;
obtaining, during the vibration of the target vibration region, a characteristic value of non-target vibration in a non-target vibration region; and
applying, based on the characteristic value of the non-target vibration in the non-target vibration region, damping vibration having a phase opposite to a phase of the non-target vibration to the non-target vibration region.

12. The local vibration adjustment method according to claim 11, wherein the characteristic value of the non-target vibration comprises a phase, an amplitude, a direction, and a frequency.

13. The local vibration adjustment method according to claim 11, wherein the characteristic value of the non-target vibration comprises at least a characteristic value of a vibration component of the non-target vibration in one direction, and a direction of the damping vibration is the same as a direction of at least one vibration component of the non-target vibration.

14. An electronic device, comprising:
the vibration apparatus according to claim 1, wherein the excitation modules in the vibration apparatus correspond to vibration regions of the electronic device.

15. The electronic device according to claim 14, further comprising:
an apparatus, configured to generate the requirement of the target haptic sensation based on a trigger event.

16. The electronic device according to claim 14, wherein
each of the excitation modules comprises an exciter and a driver, and the exciter is arranged in the vibration region corresponding to the excitation module;
the driver of the excitation module corresponding to the target vibration region is configured to receive the first vibration control signal and drive, based on the first vibration control signal, the exciter of the excitation module corresponding to the target vibration region to generate target vibration having a frequency and an intensity corresponding to the first vibration control signal; and
the driver of the excitation module corresponding to the non-target vibration region is configured to receive the second vibration control signal and drive, based on the second vibration control signal, the exciter of the excitation module corresponding to the non-target vibration region to generate the damping vibration having a frequency and an intensity corresponding to the second vibration control signal.

17. The electronic device according to claim 14, wherein a vibration sensing module is arranged in each of the at least one non-target vibration region.

18. The electronic device according to claim 14, wherein a vibration sensing module is arranged in each of the vibration regions.

19. The electronic device according to claim 14, the vibration sensing module comprising at least one vibration sensor, and the vibration sensor comprises at least one of an acceleration sensor, a speed sensor and an eddy current sensor, wherein each of the at least one vibration sensor is arranged on an extension line along a vibration direction of an excitation module in a vibration region.

20. The electronic device according to claim 16, wherein the exciter in the non-target vibration region has two or more vibration directions.
